(19) United States
(12) Patent Application Publication
(10) Pub. No.: US 2005/0181634 A1
(43) Pub. Date: Aug. 18, 2005

(54) Personal device embedded synch connector

(75) Inventor: Kulvir Singh Bhogal, Fort Worth, TX (US)

Correspondence Address: BRACEWELL & PATTERSON, L.L.P., P.O. BOX 969, AUSTIN, TX, 78767-0969, US

(73) Assignee: International Business Machines Corp., Armonk, NY (US)

(21) Appl. No.: 10/777,907

(22) Filed: Feb. 12, 2004

(51) Int. Cl. H01R 39/00

(52) U.S. Cl. 439/1; 361/679

(57) ABSTRACT

A USB connector structure embedded within a personal electronic device has a USB port and a rigid arm structure attached to the USB port, wherein the first arm structure has a hinge mechanism fixedly attached thereto that is adapted for attachment to a personal electronic device such that the USB connector structure is rotatably mounted to the personal electronic device, and having electrical connections to the USB port that provide USB communications between a USB device connected to the USB port and a personal electronic device attached to the hinge mechanism. A rigid second arm structure is attached between the USB port and the first arm structure such that the first arm structure is rotatably connected to the second arm structure.

### BACKGROUND OF THE INVENTION

1. Field of the Invention

The present invention relates to an electrical connecting structure for a communication port of a personal device, and more particularly to an electrical connecting structure embedded within a personal digital assistant (PDA) or other personal device for communication with another system.

2. Description of the Prior Art

A USB (Universal Serial Bus) interface is one of the most popular electronic communication connecting means these days, and is known to include terminals, plugs, connectors and so on, which serve to connect USB devices such as memory sticks and wireless LAN cards to USB ports of personal computers, notebooks, PDAs and so on. As compared with the prior art, currently used personal computers require connection of a number of USB devices such as telephones, modems, printers, microphones, speakers, mice and scanners as various application programs are developed. To achieve such connection of USB devices and computer units, USB interfaces, which are convenient and excellent in function, are currently used. Because the USB interfaces enable USB devices to be easily connected to computer units, and have functions such as hot plugging and Plug and Play, they have advantages in that users do not need to shut down and restart their personal computers to connect USB devices to the computers.

In such connection, though prior art USB devices use a cable type USB interface as illustrated in FIG. 1, there are many times when USB devices need to be directly connected to computers without a cable to obtain miniaturization of products. FIG. 2 shows an example of a USB device employing a USB interface in a memory stick 200. In practice, the memory stick shown in FIG. 2 is connected to a computer unit, as illustrated in FIG. 3. More specifically, the memory stick 200 has a USB male connector 202 that is connected to a female USB connector (not shown) in the computer unit 102 such that the memory stick is projected there from. More specifically, the memory stick 200 as seen in FIG. 2 includes a male USB connector port 202 that projects out from the memory stick and is always exposed to the outside environment when not inserted in a female USB port. Hence, this memory stick structure is unstable and apt to be broken at the male USB connector port if an external impact occurs on the connector port 202.

As will now be appreciated, it would be desirable to provide a USB connector interface that does not require use of a separate USB synch connector cable to connect up with another USB device. This will prevent having to keep track of and always having access to a connector cable to make a USB connection. Also, it would be desirable to provide a USB connector interface that provides protection to the male USB connector port when not engaged with a female port and exposed to the environment.

### SUMMARY OF THE INVENTION

In accordance with the present invention, a USB connector structure embedded within a personal electronic device has a USB port and a rigid arm structure attached to the USB port, wherein the first arm structure has a hinge mechanism fixedly attached thereto that is adapted for attachment to a personal electronic device such that the USB connector structure is rotatably mounted to the personal electronic device, and having electrical connections to the USB port that provide USB communications between a USB device connected to the USB port and a personal electronic device attached to the hinge mechanism.

All objects, features, and advantages of the present invention will become apparent in the following detailed written description.

### BRIEF DESCRIPTION OF THE DRAWINGS

This invention is described in a preferred embodiment in the following description with reference to the drawings, in which like numbers represent the same or similar elements, as follows:

FIG. 1 is a perspective view showing a conventional USB device, which is adapted to connect to a computer unit by a cable.

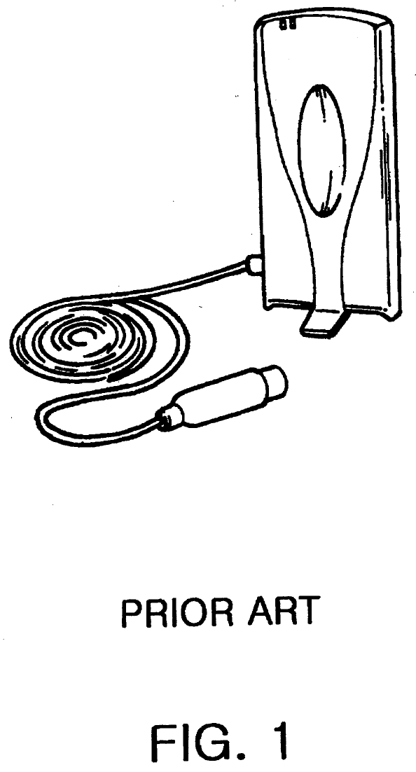

FIG. 2 is a perspective view showing an improved conventional USB device, which has no cable.

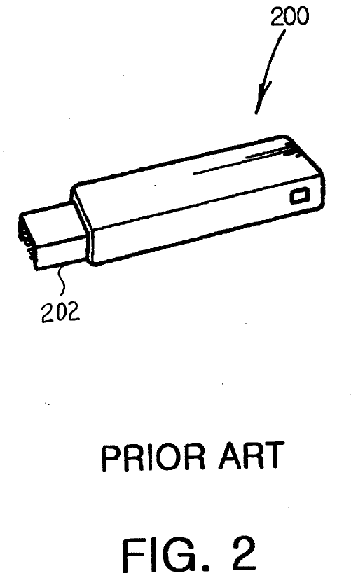

FIG. 3 is a perspective view showing the USB device of FIG. 2 coupled to a computer unit.

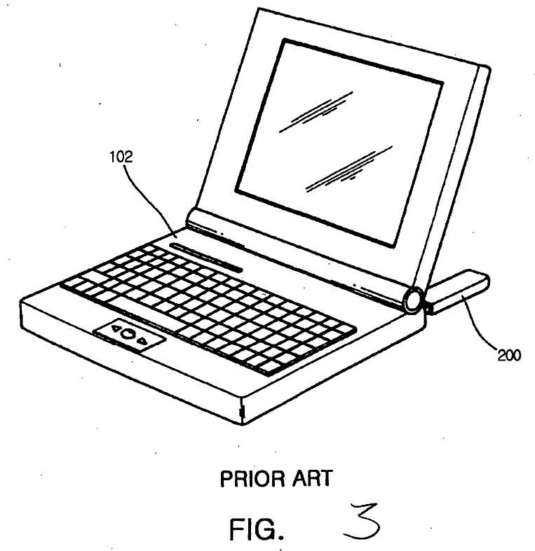

FIG. 4 shows a bottom view of a personal device, in accordance with a preferred embodiment of the present invention.

FIG. 5 shows a side view of a personal device, in accordance with a preferred embodiment of the present invention.

FIG. 6 shows a side view of the personal device having connector partially rotated out of its embedded position within personal device, in accordance with a preferred embodiment of the present invention.

FIG. 7 shows a perspective view of the connector having a first arm in a swiveled position relative to a second arm, in accordance with a preferred embodiment of the present invention.

FIG. 8 shows a bottom view of the personal device without USB connector embedded therein, in accordance with the preferred embodiment of the present invention.

### DETAILED DESCRIPTION OF PREFERRED EMBODIMENTS

In the following detailed description of exemplary embodiments of the invention, reference is made to the accompanying drawings, which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

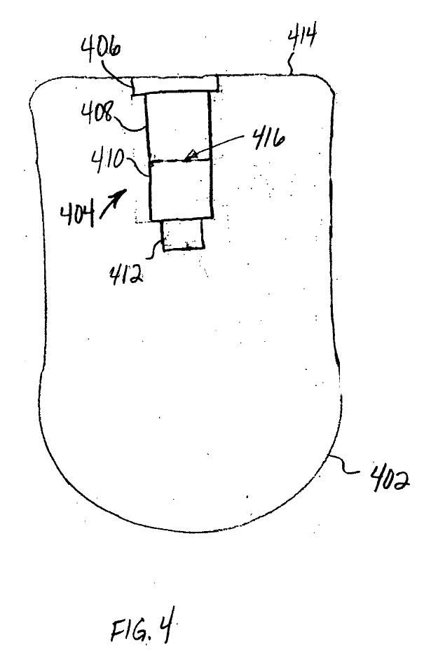

FIG. 4 is a bottom view of a personal device 402 such as a PDA, cell phone, Global Positioning System (GPS) locating device or other handheld device. Embedded within the personal device 402 is a hinged synching connector 404, in accordance with a preferred embodiment of the present invention. According to the present invention, the hinged synching connector 404 can be applied to any personal electronic device such as computer units, PDAs, cell phones and so on, which have need for USB port connections. In a preferred embodiment, hinged synching connector 404 is a connector configured for USB (Universal Serial Bus) communication. USB is an industry standard and is currently specified by USB Specification Revision 2.0. It will be appreciated that while a preferred embodiment utilizes the popular USB-compliant device, the present invention may be implemented using any communication standard and is not limited to USB. For example, connector 404 can be compliant with FireWire (Apple Computer's implementation of the IEEE 1394b standard) or other communication bus standards.

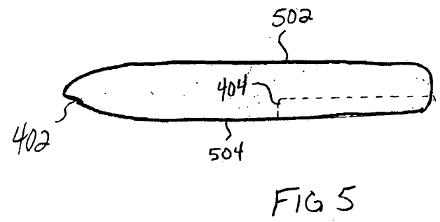

As will be appreciated, the hinged USB synching connector 404 is flushly embedded within the bottom surface of the personal device 402 such that no portion of the connector 404 protrudes from the bottom of the personal device 402, as can be seen in FIG. 5. FIG. 5 shows a side view of personal device 402. Personal device 402 has a top surface 502 and a bottom surface 504. Connector 404 is embedded within personal device 402 as shown in phantom by dashed lines in FIG. 5. Further, connector 404 is embedded in a manner such that it is mounted flush with surface 504.

Returning to FIG. 4, hinged USB synching connector 404 is rotatably connected to personal device 402 at hinge 406. Hinge 406 allows connector 404 to rotate from the embedded position within personal device 402 (as shown in FIGS. 4 and 5), through a 180-degree arc, to a fully extended position in front of end 414 of personal device 402. Fixedly attached to hinge 406 is arm 408. Rotatably attached to arm 408 is arm 410. Arm 410 swivels about the center axis of arm 408 at swivel point 416. Fixedly attached to arm 410 is male USB connector port 412. Running from male USB connector port 412 through the center of arms 408, 410 and hinge 406 are connector components and electrical connections to provide USB communications between personal device 402 and a USB device connected at port 412.

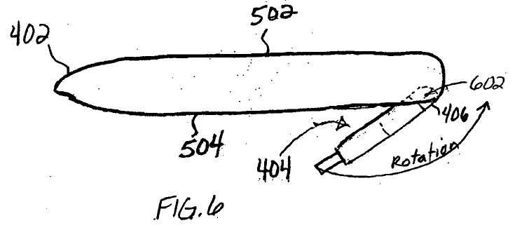

FIG. 6 shows a side view of personal device 402 having connector 404 partially rotated out of its embedded position within personal device 402, with the hidden portion of connector 404 shown in dashed lines. Connector 404 rotates around hinged point 602 by hinge 406.

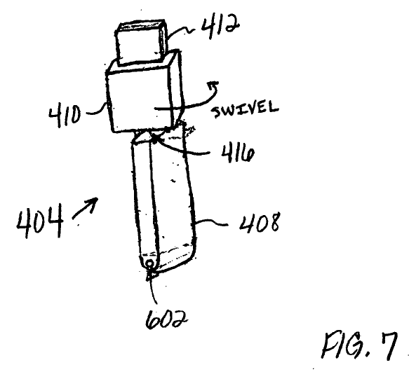

With reference now to FIG. 7, there is shown a perspective view of connector 404 having arm 410 in a swiveled position relative to arm 408. As will be appreciated by those skilled in the art, arm 410 is in a swiveled position when the axis through the center of the width of arm 408 is not parallel to the axis through the width of arm 410. Arm 410 is shown swiveled at 90° to arm 408 through the center axis of swivel point 416. In an embodiment, arm 410 is attached to arm 408 at swivel point 416 using a standard pin mechanism, as is well know by those skilled in the art. This swivel feature allows port 412 to be conveniently aligned for mating with another USB device, without requiring the personal device 402 to be rotated to accommodate the orientation of the connecting device's port. In an embodiment, a hinge insert is placed within a cylindrical tunnel at hinge point 602 and attaches at each end to personal device 402, thereby rotatably mounting connector 404 to personal device 402.

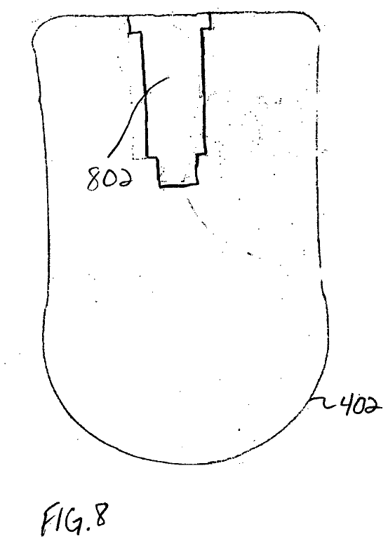

FIG. 8 shows a bottom view of personal device 402 without USB connector 404 embedded therein, in accordance with the preferred embodiment of the present invention. Personal electronic device 402 includes an inset 802 that comprises a cavity or embedded space within the personal electronic device 402 adapted to match USB connector 404 and house it therein. In a preferred embodiment, inset 402 is formed such that USB connector 404 is flushly contiguous with surface 504 when housed within inset 802.

While the invention has been particularly shown and described with reference to a preferred embodiment, it will be understood by those skilled in the art that various changes in form and detail may be made therein without departing from the spirit and scope of the invention.

1. A communication connector structure embedded within a personal electronic device, comprising:
a communication port; and
a rigid first arm structure attached to the communication port, wherein the first arm structure has a hinge mechanism fixedly attached thereto that is adapted for attachment to a personal electronic device such that the communication connector structure is rotatably mounted to the personal electronic device, and having electrical connections to the communication port that provide communication between a device connected to the communication port and the personal electronic device attached to the hinge mechanism.

2. The connecting structure of claim 1, further comprising a rigid second arm structure attached between the communication port and the first arm structure, wherein the communication port is attached to one end of the second arm structure and the first arm structure is rotatably connected to another end of the second arm structure.

3. The communication connector according to claim 2, wherein the second arm structure swivels about an axis running through the center of the longest dimension of the first arm structure.

4. The communication connector according to claim 1, wherein the communication port is a USB port.

5. The communication connector according to claim 1, wherein the communication port is a FireWire port.

6. A personal electronic device having an embedded communication connector, comprising:
a body;
a communication connector structure, comprising:
a communication port; and
a rigid first arm structure attached to the communication port, wherein the first arm structure has a hinge mechanism fixedly attached thereto and attached to the body such that the communication connector structure is rotatably mounted to the personal electronic device, and having electrical connections to the communication port that provide communication between a device connected to the communication port and the personal electronic device attached to the hinge mechanism;
an inset region within the body, inset from the surface of the body, adapted to permit the communication connector structure to occupy the space within the inset region, and wherein the hinge mechanism is positioned on the rigid first arm structure and attached to the body such that the communication connector structure occupies the inset region when rotated in a first position and extends outside the inset region when rotated in a second position.

7. The personal electronic device according to claim 6, wherein the communication connector structure is rotatably mounted to the personal electronic device by the hinge mechanism such that the communication connector structure is in a embedded position when occupying the inset region of the personal electronic device, and is in an operational position for connection with a device when the communication connector structure is rotated about a hinged point in the hinge mechanism such that the communication connector structure is moved from the embedded position and the communication port is moved outside the inset region into a position for mating with another device.

8. The personal electronic device of claim 6, further comprising:
a rigid second arm structure attached between the communication port and the first arm structure, wherein the communication port is attached to one end of the second arm structure and the first arm structure is rotatably connected to another end of the second arm structure, wherein the second arm structure rotates about an axis running through the center of the longest dimension of the first arm.

9. The personal electronic device of claim 6, wherein the personal electronic device is a personal digital assistant device.

10. The personal electronic device of claim 6, wherein the personal electronic device is a cellular telephone.

11. The personal electronic device of claim 6, wherein the personal electronic device is a notebook computer.

12. The personal electronic device of claim 6, wherein the personal electronic device is a portable device adapted to be carried on the person of the user of the personal electronic device.

13. The communication connector according to claim 6, wherein the communication port is a USB port.

14. The communication connector according to claim 6, wherein the communication port is a FireWire port.
